(19) United States
(12) Patent Application Publication
(10) Pub. No.: US 2014/0117886 A1
(43) Pub. Date: May 1, 2014

(54) POWER OUTPUT SYSTEM AND CONTROL METHOD THEREOF

(71) Applicant: INDUSTRIAL TECHNOLOGY RESEARCH INSTITUTE, Hsinchu (TW)

(72) Inventor: Chien-Hsun Wu, New Taipei (TW)

(73) Assignee: INDUSTRIAL TECHNOLOGY RESEARCH INSTITUTE, Hsinchu (TW)

(21) Appl. No.: 13/757,623

(22) Filed: Feb. 1, 2013

(30) Foreign Application Priority Data
Oct. 31, 2012 (TW) 101140422

(51) Int. Cl. H02P 5/00; H02K 7/108; H02K 16/00

(52) U.S. Cl. CPC H02P 5/00; H02K 16/00; H02K 7/108
USPC 318/46; 310/112; 310/78

(57) ABSTRACT

A power output system includes a first rotary power source, a second rotary power source and a clutch. The first rotary power source has a first maximum torque and a first maximum rotation speed. The second rotary power source has a second maximum torque and a second maximum rotation speed. The second maximum torque is greater than the first maximum torque, and the second maximum rotation speed is lower than the first maximum rotation speed. An output shaft of the second rotary power source is coaxial with an output shaft of the first rotary power source. The clutch is located between the first rotary power source and the second rotary power source. The clutch separates or couples the output shaft of the first rotary power source from or to the output shaft of the second rotary power source.

### CROSS-REFERENCE TO RELATED APPLICATIONS

This non-provisional application claims priority under 35 U.S.C. §119(a) on Patent Application No(s) 101140422 filed in Taiwan, R.O.C. on Oct. 31, 2012, the entire contents of which are hereby incorporated by reference.

### TECHNICAL FIELD

The disclosure relates to a power output system and a control method thereof, and more particularly to a power output system having a plurality of rotary power sources and a control method thereof.

### BACKGROUND

The permanent magnet motor is highly efficient and is widely used in electromobiles. However, the permanent magnet motor, at the same time, generally does not have the power characteristics of high torque and high rotation speed required by the electromobile.

Specifically, a permanent magnet motor with a high torque generally does not involve a high rotation speed, while a permanent magnet motor with a high rotation speed generally does not involve a high torque. To address this issue, several methods can be applied to raise the rotation speed of a motor system with a high torque. For example, viable solutions include adding a gear box in the motor system, implementing flux-weakening control on the motor system, or integrating a driver in the motor system with a boost circuit.

However, the addition of the gear box in the motor system may increase the overall volume of the motor system. The implementation of the flux-weakening control may lower the efficiency of the motor system and cause demagnetization. The integration of the motor driver and the boost circuit may considerably increase the cost.

Therefore, in the development of the motor system, how to provide a motor system having both a high torque and a high rotation speed and improve the operating efficiency of the motor has become an important issue.

### SUMMARY

In an embodiment, the disclosure provides a power output system comprising a first rotary power source, a second rotary power source and a clutch. The first rotary power source has a first maximum torque and a first maximum rotation speed. The second rotary source has a second maximum torque and a second maximum rotation speed. The second maximum torque is greater than the first maximum torque. The second maximum rotation speed is lower than the first maximum rotation speed. An output shaft of the second rotary power source is coaxial with an output shaft of the first rotary power source. The clutch is located between the first rotary power source and the second rotary power source. The clutch is configured for separating or coupling the output shaft of the first rotary power source from or to the output shaft of the second rotary power source.

According to an embodiment, a control method of a power output system is disclosed. In the method, a power output system is provided. The power output system comprises a first rotary power source, a second rotary power source and a clutch. A maximum torque of the second rotary power source is greater than a maximum torque of the first rotary power source. A maximum rotation speed of the second rotary power source is lower than a maximum rotation speed of the first rotary power source. A preset rotation speed is set, and it is determined whether a rotation speed to be output by the power output system is greater than the preset rotation speed. If the rotation speed to be output by the power output system is greater than the preset rotation speed, the clutch is switched off to separate the first rotary power source from the second rotary power source, and stop the output of the second rotary power source. If the rotation speed to be output by the power output system is less than the preset rotation speed, the clutch is switched on to coaxially couple the first rotary power source and the second rotary power source for synchronous output.

### BRIEF DESCRIPTION OF THE DRAWINGS

The disclosure will become more fully understood from the detailed description given herein below for illustration only, and thus does not limit the disclosure, wherein:

FIG. 1 is a structural layout of a power output system according to an embodiment of the disclosure;

FIG. 2A is a rotation speed-torque graph of a single first rotary power source in FIG. 1;

FIG. 2B is a rotation speed-torque graph of a single second rotary power source in FIG. 1;

FIG. 2C is an overall rotation speed-torque graph of the power output system in FIG. 1; and

FIG. 3 and FIG. 4 are flow charts of a control method of a power output system according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

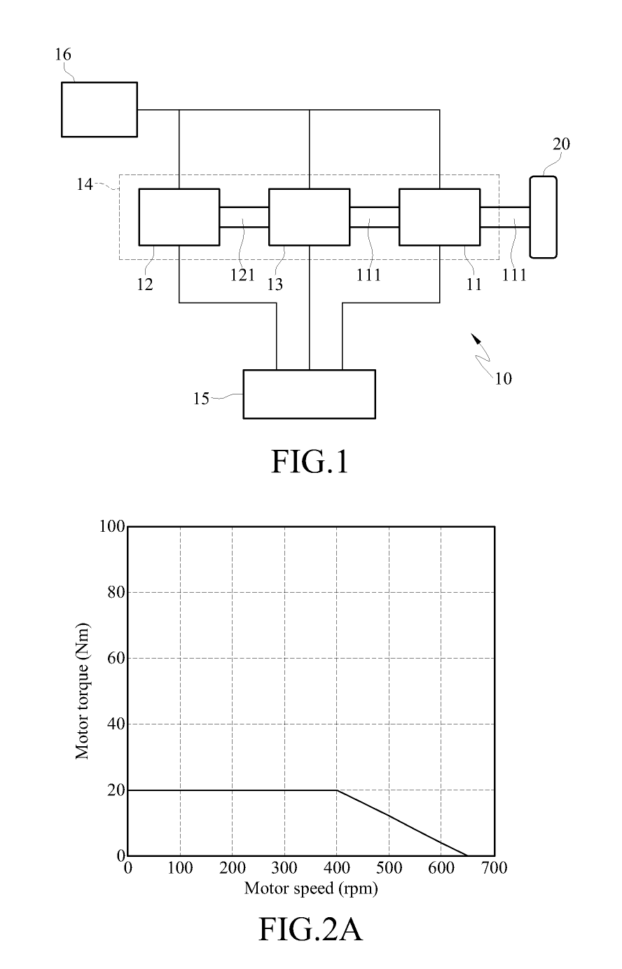

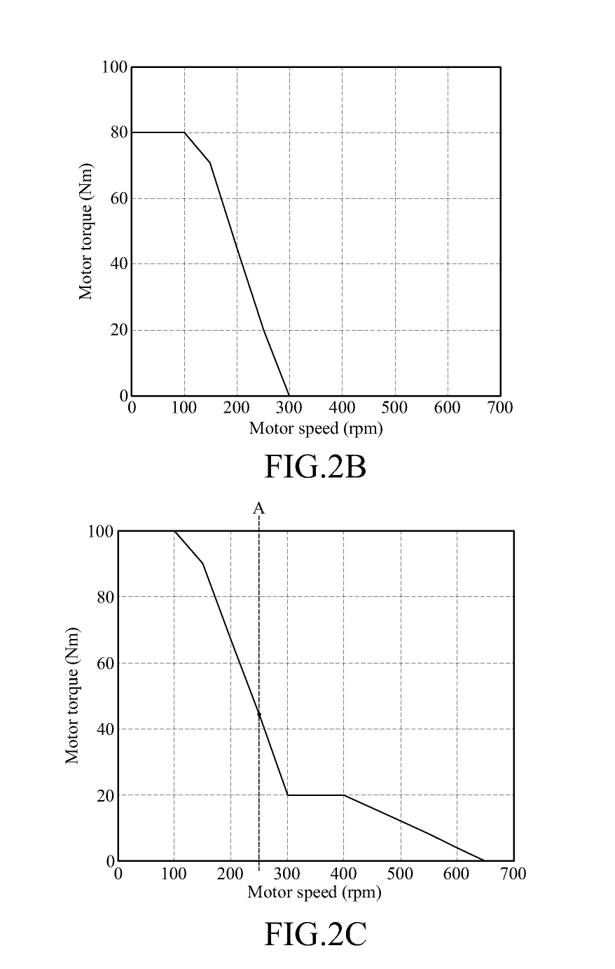

Please refer to FIG. 1 to FIG. 2C. FIG. 1 is a structural layout of a power output system according to an embodiment of the disclosure. FIG. 2A is a rotation speed-torque graph of a single first rotary power source in FIG. 1. FIG. 2B is a rotation speed-torque graph of a single second rotary power source in FIG. 1. FIG. 2C is an overall rotation speed-torque graph of the power output system in FIG. 1.

In this and some other embodiments, the power output system 10 is configured for an in-wheel motor system of an electromobile, but the disclosure is not limited thereto.

The power output system 10 comprises a first rotary power source 11, a second rotary power source 12 and a clutch 13.

In this and some other embodiments, the motor characteristic of the first rotary power source 11 is shown in FIG. 2A, where the first rotary power source 11 has a first maximum torque of 20 Nm at a rotation speed of 0-400 rpm, and has a first maximum rotation speed of 650 rpm.

In this and some other embodiments, the motor characteristic of the second rotary power source 12 is shown in FIG. 2B, where the second rotary power source 12 has a second maximum torque of 80 Nm at a rotation speed of 0-100 rpm, and has a second maximum rotation speed of 300 rpm.

Specifically, the second maximum torque (80 Nm) is greater than the first maximum torque (20 Nm), and the second maximum rotation speed (300 rpm) is lower than the first maximum rotation speed (650 rpm). In other words, the maximum torque of the second rotary power source 12 is greater than the maximum torque of the first rotary power source 11, and the maximum rotation speed of the second rotary power source 12 is lower than the maximum rotation speed of the first rotary power source 11. Therefore, In this and some other embodiments, the first rotary power source 11 is regarded as a motor having a high rotation speed and a low torque, while the second rotary power source 12 is regarded as a motor having a low rotation speed and a high torque.

Moreover, an output shaft 121 of the second rotary power source 12 is coaxial with an output shaft 111 of the first rotary power source 11.

In this and some other embodiments, the clutch 13 is an electrically controlled clutch 13 but the disclosure is not limited thereto. The clutch 13 is located between the first rotary power source 11 and the second rotary power source 12. The clutch 13 is configured for separating or coupling the output shaft 111 of the first rotary power source 11 from or to the output shaft 121 of the second rotary power source 12. Since the output shaft 121 of the second rotary power source 12 is coaxial with the output shaft 111 of the first rotary power source 11, the output shaft 121 is coupled to the output shaft 111. Thereby, the power loss in transmission is reduced.

In this and some other embodiments, the power output system 10 further comprises a casing 14. The first rotary power source 11, the second rotary power source 12 and the clutch 13 are located inside the casing 14. That is, the first rotary power source 11, the second rotary power source 12 and the clutch 13 are integrally formed into one module.

In this and some other embodiments, the power output system 10 further comprises a controller 15 and a power supply module 16. The controller 15 is electrically connected to the first rotary power source 11, the second rotary power source 12 and the clutch 13, so as to control the operation of the first rotary power source 11, the second rotary power source 12 and the clutch 13. In this and some other embodiments, the power supply module 16 is a storage battery but the disclosure is not limited thereto. The power supply module 16 is electrically connected to the first rotary power source 11, the second rotary power source 12 and the clutch 13, so as to provide electric power required during the operations of first rotary power source 11, the second rotary power source 12 and the clutch 13.

In this and some other embodiments, when the power output system 10 is applied in an electromobile, the output shaft 111 of the first rotary power source 11 is configured for being connected to a driving wheel 20. The driving wheel 20 is a wheel of the electromobile.

The power output system 10 is designed with the first rotary power source 11 and the second rotary power source 12 having different rotation speeds and torques. Thereby, in this and some other embodiments, when the clutch 13 is switched on to couple the output shaft 111 of the first rotary power source 11 to the output shaft 121 of the second rotary power source 12 for synchronous rotation, the overall motor characteristic of the power output system 10 is shown in FIG. 2C. Specifically, in this and some other embodiments, the overall maximum torque of the power output system 10 reaches 100 Nm, and the overall maximum rotation speed of the power output system 10 remains at 650 rpm.

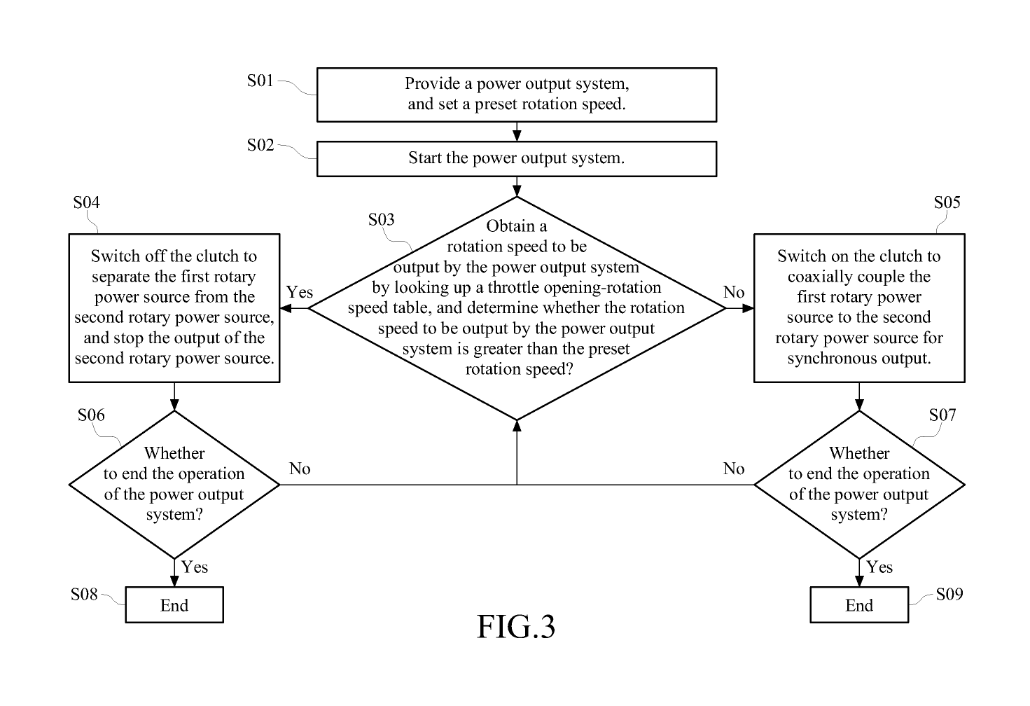

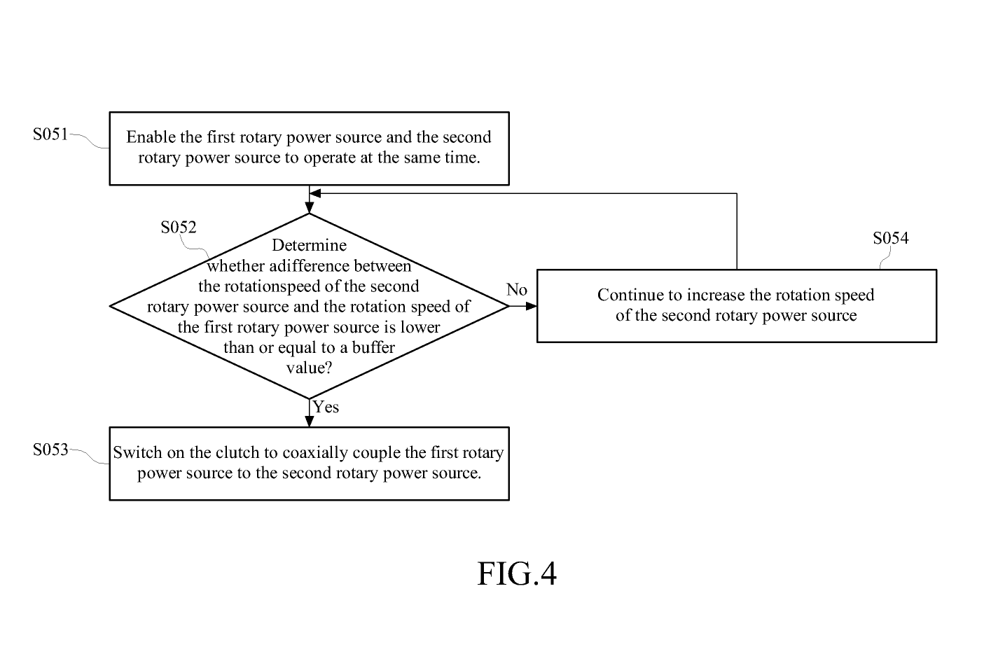

Please refer to FIG. 3 and FIG. 4 together with FIG. 1 and FIG. 2C. FIG. 3 and FIG. 4 are flow charts of a control method of a power output system according to an embodiment of the disclosure.

The control method of the power output system 10 is introduced below, where the power output system 10 is applied in an in-wheel motor system of an electromobile, and the disclosure is not limited thereto.

First referring to FIG. 3, the power output system 10 is provided, and a preset rotation speed A is set (S01).

The preset rotation speed A is determined according to the actual operating efficiency of the power output system 10, to ensure that the system has an optimal motor efficiency when the first rotary power source 11 is coupled to the second rotary power source 12 at the rotation speed A. The preset rotation speed needs to be lower than or equal to the maximum rotation speed (300 rpm) of the second rotary power source 12. In this embodiment, the preset rotation speed is 250 rpm, but the disclosure is not limited thereto.

Then, the power output system 10 is started (S02).

A rotation speed to be output by the power output system 10, then, is obtained by looking up a throttle opening-rotation speed table (S03). Furthermore, the control method further determines whether the rotation speed to be output by the power output system 10 is greater than the preset rotation speed (S03).

The throttle opening refers to the amplitude of pressing a throttle pedal by a user, and the throttle opening-rotation speed table may be looked up for the rotation speed corresponding to each throttle opening. Therefore, when the user presses the throttle pedal to a certain amplitude, a corresponding wheel rotation speed may be obtained by looking up the throttle opening-rotation speed table. Additionally, the rotation speed (namely, the wheel rotation speed) to be output is compared with the preset rotation speed A to determine the subsequent control mode. If the rotation speed to be output (for example, 350 rpm) is greater than the preset rotation speed A (for example, 250 rpm), the clutch 13 is switched off to separate the output shaft 111 of the first rotary power source 11 from the output shaft 121 of the second rotary power source 12, and stop the output of the second rotary power source 12 (S04).

Specifically, when the rotation speed to be output is greater than the preset rotation speed A, the clutch 13 is switched off to separate the second rotary power source 12 from the first rotary power source 11, and stop the output of the second rotary power source 12. If the rotation speed to be output (for example, 200 rpm) is lower than or equal to the preset rotation speed A (for example, 250 rpm), the clutch 13 is switched on to coaxially couple the output shaft 111 of the first rotary power source 11 to the output shaft 121 of the second rotary power source 12 for synchronous output (S05).

Specifically, when the rotation speed to be output is lower than or equal to the preset rotation speed A, the electromobile is expected to have a high torque and a low rotation speed. Therefore, the clutch 13 is switched on to coaxially couple the output shaft 111 of the first rotary power source 11 to the output shaft 121 of the second rotary power source 12, so as to superimpose the output torques of the first rotary power source 11 and the second rotary power source 12. Hence, the power output system 10 achieves a preferable overall motor torque.

Referring to FIG. 4, in Step (S05), the control method of coaxially coupling the first rotary power source 11 and the second rotary power source 12 for synchronous output further comprises the following steps.

Firstly, the first rotary power source 11 and the second rotary power source 12 are enabled to operate at the same time (S051).

Then, it is determined whether a difference between the rotation speed of the second rotary power source 12 and the rotation speed of the first rotary power source 11 is lower than or equal to a buffer value (S052).

In this and some other embodiments, the buffer value is 10% of the maximum rotation speed of the first rotary power source 11, but not limited thereto. In this embodiment, the buffer value is about 65 rpm, but the disclosure is not limited thereto. Persons skilled in the art may adjust the buffer value according to actual requirements.

If the difference between the rotation speed of the second rotary power source 12 and the rotation speed of the first rotary power source 11 is lower than or equal to the buffer value, the clutch 13 is switched on to coaxially couple the first rotary power source 11 to the second rotary power source 12 (S053).

Specifically, when the difference between the rotation speed of the second rotary power source 12 and the rotation speed of the first rotary power source 11 is lower than or equal to the buffer value, the difference is appropriate and not excessive. At this time, the output shaft 121 of the second rotary power source 12 is coupled to the output shaft 111 of the first rotary power source 11, so that the output of the rotation speed of the power output system 10 remains stable. Thereby, the operating efficiency of the power output system 10 is improved.

If the difference between the rotation speed of the second rotary power source 12 and the rotation speed of the first rotary power source 11 is greater than the buffer value, the rotation speed of the second rotary power source 12 is continued to be increased (S054).

Specifically, when the difference between the rotation speed of the second rotary power source 12 and the rotation speed of the first rotary power source 11 is greater than the buffer value, the difference is excessive. If the output shaft 121 of the second rotary power source 12 is forcedly coupled to the output shaft 111 of the first rotary power source 11 at this time, the output of the rotation speed of the power output system 10 becomes unstable, and the operating efficiency of the power output system 10 is lowered. Thereby, the clutch 13 is damaged. To address this issue, when the difference between the rotation speed of the second rotary power source 12 and the rotation speed of the first rotary power source 11 is excessive, the rotation speed of the second rotary power source 12 is continued to be increased to approach the rotation speed of the first rotary power source 11.

Further referring to FIG. 3, after Step (S04), it is determined whether to end the operation of the power output system 10 (S06).

If yes, end the operation of the power output system 10 (S08).

If not, return to Step (S03), to determine whether the rotation speed to be output by the power output system 10 is greater than the preset rotation speed, so as to control the power output system 10 to maintain the status in Step (S04) that the first rotary power source 11 is separated from the second rotary power source 12 and the second rotary power source 12 stops output, or to switch to the status in Step (S05).

Similarly, after Step (S05), it is also determined whether to end the operation of the power output system 10 (S07).

If yes, end the operation of the power output system 10 (S09).

If not, return to Step (S03), to determine whether the rotation speed to be output by the power output system 10 is greater than the preset rotation speed, so as to control the power output system 10 to maintain the status in Step (S05) that the first rotary power source 11 is coupled to the second rotary power source 12 for synchronous output, or to switch to the status in Step (S04).

According to the power output system and the control method thereof provided in the foregoing embodiments, the first rotary power source and the second rotary power source having different motor characteristics are coaxially disposed. Additionally, the clutch is configured for separating or coupling the output shaft of the first rotary power source from or to the output shaft of the second rotary power source. Thereby, the first rotary power source and the second rotary power source may be stacked and rotate together, so that the power output system achieves a large system motor torque.

What is claimed is:

1. A power output system, comprising:
a first rotary power source having a first maximum torque and a first maximum rotation speed;
a second rotary power source having a second maximum torque and a second maximum rotation speed, the second maximum torque being greater than the first maximum torque, the second maximum rotation speed being lower than the first maximum rotation speed, and an output shaft of the second rotary power source being coaxial with an output shaft of the first rotary power source; and
a clutch located between the first rotary power source and the second rotary power source, the clutch is configured for separating or coupling the output shaft of the first rotary power source from or to the output shaft of the second rotary power source.

2. The power output system according to claim 1, further comprising a controller electrically connected to the first rotary power source, the second rotary power source and the clutch.

3. The power output system according to claim 1, further comprising a power supply module electrically connected to the first rotary power source, the second rotary power source and the clutch.

4. The power output system according to claim 1, wherein the output shaft of the first rotary power source is connected to a driving wheel.

5. The power output system according to claim 1, further comprising a casing, the first rotary power source, the second rotary power source and the clutch being located inside the casing.

6. A control method of a power output system, comprising steps of:
providing a power output system comprising a first rotary power source, a second rotary power source and a clutch, a maximum torque of the second rotary power source being greater than a maximum torque of the first rotary power source, and a maximum rotation speed of the second rotary power source being lower than a maximum rotation speed of the first rotary power source;
setting a preset rotation speed, and determining whether a rotation speed to be output by the power output system is greater than the preset rotation speed;
if yes, switching off the clutch to separate the first rotary power source from the second rotary power source, and stop the output of the second rotary power source; and
if not, switching on the clutch to coaxially couple the first rotary power source and the second rotary power source for synchronous output.

7. The control method of the power output system according to claim 6, wherein the preset rotation speed is lower than or equal to the maximum rotation speed of the second rotary power source.

8. The control method of the power output system according to claim 6, wherein the step of switching on the clutch to coaxially couple the first rotary power source and the second rotary power source for synchronous output further comprises:
enabling the first rotary power source and the second rotary power source to operate at the same time;
determining whether a difference between the rotation speed of the second rotary power source and the rotation speed of the first rotary power source is lower than or equal to a buffer value;
if yes, switching on the clutch to coaxially couple the first rotary power source and the second rotary power source; and
if not, continuing to increase the rotation speed of the second rotary power source.

9. The control method of the power output system according to claim 8, wherein the buffer value is 10% of the maximum rotation speed of the first rotary power source.

10. The control method of the power output system according to claim 6, wherein the rotation speed to be output by the power output system is obtained by looking up a throttle opening-rotation speed table.
